(19) United States
(12) Patent Application Publication
(10) Pub. No.: US 2021/0387297 A1
(43) Pub. Date: Dec. 16, 2021

(54) FRAMED DISPLAY ITEM ASSEMBLY METHOD AND SYSTEM

(71) Applicant: The Fletcher-Terry Company, East Berlin, CT (US)

(72) Inventors: Benjamin Paharik, Hopkinton, MA (US); David B. Rose, Waverly, TN (US); William B. Travis, Burns, TN (US); Billy K. Willhite, Hurricane Mills, TN (US)

(21) Appl. No.: 17/347,111

(22) Filed: Jun. 14, 2021

Related U.S. Application Data
(60) Provisional application No. 63/038,229, filed on Jun. 12, 2020.

(51) Int. Cl. B23P 19/04

(52) U.S. Cl. CPC B23P 19/04

(57) ABSTRACT

A method and system for assembling framed display items is provided. The method includes: a) providing a substrate feeder and controlling the substrate feeder to dispense a first substrate; b) using a first robotic actuator to pick the first substrate and move it from the substrate feeder to an assembly station; c) locating the first substrate to a predetermined position on the assembly station; d) using a second robotic actuator to pick a frame from a frame station and move the frame to the assembly station. The second robotic actuator moves the frame from the frame station to the assembly station with the frame oriented such that the frame is placed over the first substrate residing at the assembly station and the first substrate is disposed within a frame rabbet; and e) installing fasteners within the frame to secure the first substrate within the frame rabbet.

The present application is entitled to the benefit of and incorporates by reference essential subject matter disclosed in the U.S. Provisional Patent Application Ser. No. 63/038,229, filed on Jun. 12, 2020.

### BACKGROUND OF THE INVENTION

### 1. Technical Field

The present disclosure is related to display material framing in general, and to methods and systems for automated assembly of framed display items in particular.

### 2. Background Information

Conventional picture framing often includes a picture frame and display material to be framed. The frame may be manually assembled or assembled in an automated manner. During assembly of the work, the picture frame is typically placed on its face, and the display material (e.g., a mirror or transparent protective substrate, a mat, display material such as artwork, photographs, posters, and the like, and a backing board) are sequentially and manually placed face down within the back of the frame; e.g., are stacked within the picture frame. Next, fasteners (often referred to as “points” or tabs”) are engaged with the frame to retain the stack-up within the frame. This is a manual, time consuming process that may be acceptable for low volume picture framing but is ill-suited for commercial applications where large volumes of framed materials are produced.

Automated frame production is often used in commercial applications to facilitate the production of a picture frame, but the remainder of the framing process often utilizes the same manual assembly techniques or automates only a portion of the process. Commercial picture framing has achieved significant success in the recent past, mass producing framed display materials that can be sold at reasonable prices. As a result, framed display materials (e.g., artwork, poster, photograph, etc.) are available to the public where heretofore they have not been available due to cost considerations.

What is needed is a method and system capable of producing framed display materials in an automated and cost effective manner.

### SUMMARY

According to an aspect of the present disclosure, a method for assembling framed display items is provided. The method includes: a) providing at least one substrate feeder, and controlling the at least one substrate feeder to dispense a first substrate; b) using a first robotic actuator to pick the dispensed first substrate and move the first substrate from the substrate feeder to an assembly station; c) locating the first substrate to a predetermined position on the assembly station; d) using a second robotic actuator to pick a frame from a frame station and moving the frame to the assembly station, the frame having a front side, a rear side, an outer perimeter, and an inner perimeter, the inner perimeter defining an opening, the rear side having a rear side surface that includes a rabbet extending around and contiguous with the inner perimeter, the rabbet forming a shelf surface, wherein the second robotic actuator is configured to move the frame from a frame station to the assembly station with the frame oriented such that the frame is placed over the first substrate residing at the assembly station and the first substrate is disposed within the frame rabbet; and e) installing a plurality of fasteners within the frame to secure the first substrate within the frame rabbet.

In any of the aspects or embodiments described above and herein, the method may include the step of controlling the assembly station to position the first substrate to the predetermined position of the assembly station.

In any of the aspects or embodiments described above and herein, the at least one substrate feeder may include a first substrate feeder that dispenses the first substrate and a second substrate feeder that dispenses a second substrate, and the method may further include: a) using the first robotic actuator to pick the second substrate from the second substrate feeder and move the second substrate to the assembly station; b) controlling the assembly station to position the second substrate to the predetermined position of the assembly station on top of the first substrate, thereby forming a stack of substrates that includes the first substrate and the second substrate; and c) wherein the second robotic actuator is configured to move the frame to the assembly station with the frame oriented such that the frame is placed over the stack of substrates residing at the assembly station at the predetermined position and the stack of substrates is disposed within the frame rabbet, wherein the step of installing the plurality of fasteners within the frame secures the stack of substrates within the frame rabbet.

In any of the aspects or embodiments described above and herein, the at least one substrate feeder may include a first substrate feeder that dispenses the first substrate and a second substrate feeder that dispenses a second substrate, and the method may further include: a) using a third robotic actuator to pick the second substrate from the second substrate feeder and move the second substrate to the assembly station; and b) controlling the assembly station to position the second substrate to the predetermined position of the assembly station on top of the first substrate, thereby forming a stack of substrates that includes the first substrate and the second substrate; wherein the second robotic actuator may be configured to move the frame to the assembly station with the frame oriented such that the frame is placed over the stack of substrates residing at the assembly station at the predetermined position and the stack of substrates is disposed within the frame rabbet, and wherein the step of installing the plurality of fasteners within the frame secures the stack of substrates within the frame rabbet.

In any of the aspects or embodiments described above and herein, the at least one substrate feeder may further include a third substrate feeder that dispenses a third substrate, and the method may further include: a) using a fourth robotic actuator to pick the third substrate from the third substrate feeder and move the third substrate to the assembly station; and b) controlling the assembly station to position the third substrate to the predetermined position of the assembly station on top of the second substrate, thereby adding the third substrate to the stack of substrates.

In any of the aspects or embodiments described above and herein, the at least one substrate feeder may include a first substrate feeder that dispenses the first substrate and a second substrate feeder that dispenses a second substrate, and the method may include: a) using a third robotic actuator to pick the second substrate from the second substrate feeder and move the second substrate to an adhesive station; b) controlling the adhesive station to apply an amount of adhesive to a surface of the second substrate; c) using a fourth robotic actuator to pick the second substrate from the adhesive station and move the second substrate to the assembly station; and d) controlling the assembly station to position the second substrate to the predetermined position of the assembly station on top of the first substrate, thereby forming a stack of substrates that includes the first substrate and the second substrate, wherein the second robotic actuator is configured to move the frame to the assembly station with the frame oriented such that the frame is placed over the stack of substrates residing at the assembly station at the predetermined position and the stack of substrates is disposed within the frame rabbet and the amount of adhesive applied to the surface of the second substrate is disposed between and in contact with the shelf surface of the frame and the second substrate surface, and wherein the step of installing the plurality of fasteners within the frame secures the stack of substrates within the frame rabbet.

In any of the aspects or embodiments described above and herein, the at least one substrate feeder may include a first substrate feeder that dispenses the first substrate and a second substrate feeder that dispenses a second substrate, and the method may include: a) using a third robotic actuator to pick the second substrate from the second substrate feeder and move the second substrate to a film removing station; b) controlling the film removing station to remove a protective film attached to a surface of the second substrate; c) using a fourth robotic actuator to pick the second substrate from the film removing station and move the second substrate to the assembly station; and d) controlling the assembly station to position the second substrate to the predetermined position of the assembly station on top of the first substrate, thereby forming a stack of substrates that includes the first substrate and the second substrate; wherein the second robotic actuator is configured to move the frame to the assembly station with the frame oriented such that the frame is placed over the stack of substrates residing at the assembly station at the predetermined position and the stack of substrates is disposed within the frame rabbet, and wherein the step of installing the plurality of fasteners within the frame secures the stack of substrates within the frame rabbet.

In any of the aspects or embodiments described above and herein, the at least one substrate feeder may include a first substrate feeder that dispenses the first substrate and a second substrate feeder that dispenses a second substrate, and the method may include: a) using a third robotic actuator to pick the second substrate from the second substrate feeder and move the second substrate to a film removing station; b) controlling the film removing station to remove a protective film attached to a surface of the second substrate; c) using a fourth robotic actuator to pick the second substrate from the film removing station and move the second substrate to an adhesive station; d) controlling the adhesive station to apply an amount of adhesive to a surface of the second substrate; e) using a fifth robotic actuator to pick the second substrate from the adhesive station and move the second substrate to the assembly station; and f) controlling the assembly station to position the second substrate to the predetermined position of the assembly station on top of the first substrate, thereby forming a stack of substrates that includes the first substrate and the second substrate, wherein the second robotic actuator is configured to move the frame to the assembly station with the frame oriented such that the frame is placed over the stack of substrates residing at the assembly station at the predetermined position and the stack of substrates is disposed within the frame rabbet, and wherein the step of installing the plurality of fasteners within the frame secures the stack of substrates within the frame rabbet to form the framed display item.

In any of the aspects or embodiments described above and herein, the method may further include using the second actuator to pick the framed display item from the assembly station and move the framed display item to an exit station.

According to an aspect of the present disclosure, a system for assembling framed display items is provided that includes at least one substrate feeder, a first robotic actuator, a second robotic actuator, an assembly station, a frame station, and a system controller. The system controller is in communication with the at least one substrate feeder, the first robotic actuator, the second robotic actuator, and the assembly station. The controller includes at least one processor and a memory device configured to store instructions, the stored instructions when executed cause the controller to: a) control the at least one substrate feeder to dispense a first substrate; b) control the first robotic actuator to pick the dispensed first substrate and move the first substrate from the substrate feeder to an assembly station; c) control the assembly station to locate the first substrate to a predetermined position on the assembly station; d) control the second robotic actuator to pick a frame from the frame station and move the frame to the assembly station, the frame having a front side, a rear side, an outer perimeter, and an inner perimeter, the inner perimeter defining an opening, the rear side having a rear side surface that includes a rabbet extending around and contiguous with the inner perimeter, the rabbet forming a shelf surface; e) control the second robotic actuator to move the frame from the frame station to the assembly station with the frame oriented such that the frame is placed over the first substrate residing at the assembly station and the first substrate is disposed within the frame rabbet; and f) control the assembly station to install a plurality of fasteners within the frame to secure the first substrate within the frame rabbet.

In any of the aspects or embodiments described above and herein, the stored instructions when executed may cause the system controller to control the assembly station to position the first substrate to the predetermined position of the assembly station.

In any of the aspects or embodiments described above and herein, the at least one substrate feeder may include a first substrate feeder configured to dispense the first substrate and a second substrate feeder configured to dispense a second substrate. The stored instructions when executed may cause the system controller to: a) control the first robotic actuator to pick the second substrate from the second substrate feeder and move the second substrate to the assembly station; b) control the assembly station to position the second substrate to the predetermined position of the assembly station on top of the first substrate, thereby forming a stack of substrates that includes the first substrate and the second substrate; and c) control the second robotic actuator to move the frame to the assembly station with the frame oriented such that the frame is placed over the stack of substrates residing at the assembly station at the predetermined position and the stack of substrates is disposed within the frame rabbet. The plurality of fasteners installed within the frame secures the stack of substrates within the frame rabbet.

In any of the aspects or embodiments described above and herein, the at least one substrate feeder may include a first substrate feeder configured to dispense the first substrate and a second substrate feeder configured to dispense a second substrate. The system may further include a third robotic actuator. The stored instructions when executed may cause the system controller to: a) control the third robotic actuator to pick the second substrate from the second substrate feeder and move the second substrate to the assembly station; b) control the assembly station to position the second substrate to the predetermined position of the assembly station on top of the first substrate, thereby forming a stack of substrates that includes the first substrate and the second substrate; and c) control the second robotic actuator to move the frame to the assembly station with the frame oriented such that the frame is placed over the stack of substrates residing at the assembly station at the predetermined position and the stack of substrates is disposed within the frame rabbet. The plurality of fasteners installed within the frame secures the stack of substrates within the frame rabbet.

In any of the aspects or embodiments described above and herein, the at least one substrate feeder may further include a third substrate feeder configured to dispense a third substrate, and the system may further include a fourth robotic actuator. The stored instructions when executed may cause the system controller to: a) control the fourth robotic actuator to pick the third substrate from the third substrate feeder and move the third substrate to the assembly station; and b) control the assembly station to position the third substrate to the predetermined position of the assembly station on top of the second substrate, thereby adding the third substrate to the stack of substrates.

In any of the aspects or embodiments described above and herein, the at least one substrate feeder may include a first substrate feeder that dispenses the first substrate and a second substrate feeder that dispenses a second substrate. The system may further include a third robotic actuator, a fourth robotic actuator, and an adhesive station. The stored instructions when executed cause the system controller to: a) control the third robotic actuator to pick the second substrate from the second substrate feeder and move the second substrate to the adhesive station; b) control the adhesive station to apply an amount of adhesive to a surface of the second substrate; c) control the fourth robotic actuator to pick the second substrate from the adhesive station and move the second substrate to the assembly station; d) control the assembly station to position the second substrate to the predetermined position of the assembly station on top of the first substrate, thereby forming a stack of substrates that includes the first substrate and the second substrate; and e) control the second robotic actuator to move the frame to the assembly station with the frame oriented such that the frame is placed over the stack of substrates residing at the assembly station at the predetermined position and the stack of substrates is disposed within the frame rabbet. The plurality of fasteners installed within the frame secures the stack of substrates within the frame rabbet.

In any of the aspects or embodiments described above and herein, the at least one substrate feeder may include a first substrate feeder that dispenses the first substrate and a second substrate feeder that dispenses a second substrate. The system may further include a third robotic actuator, a fourth robotic actuator, and a film removing station. The stored instructions when executed may cause the system controller to: a) control the third robotic actuator to pick the second substrate from the second substrate feeder and move the second substrate to the film removing station; b) control the film removing station to remove a protective film attached to a surface of the second substrate; c) control the fourth robotic actuator to pick the second substrate from the film removing station and move the second substrate to the assembly station; d) control the assembly station to position the second substrate to the predetermined position of the assembly station on top of the first substrate, thereby forming a stack of substrates that includes the first substrate and the second substrate; and e) control the second robotic actuator to move the frame to the assembly station with the frame oriented such that the frame is placed over the stack of substrates residing at the assembly station at the predetermined position and the stack of substrates is disposed within the frame rabbet. The plurality of fasteners installed within the frame secures the stack of substrates within the frame rabbet.

In any of the aspects or embodiments described above and herein, the at least one substrate feeder may include a first substrate feeder that dispenses the first substrate and a second substrate feeder that dispenses a second substrate. The system may further include a third robotic actuator, a fourth robotic actuator, a fifth robotic actuator, a film removing station, and an adhesive station. The stored instructions when executed may cause the system controller to: a) control the third robotic actuator to pick the second substrate from the second substrate feeder and move the second substrate to the film removing station; b) control the film removing station to remove a protective film attached to a surface of the second substrate; c) control the fourth robotic actuator to pick the second substrate from the film removing station and move the second substrate to the adhesive station; d) control the adhesive station to apply an amount of adhesive to a surface of the second substrate; e) control the fifth robotic actuator to pick the second substrate from the adhesive station and move the second substrate to the assembly station; f) control the assembly station to position the second substrate to the predetermined position of the assembly station on top of the first substrate, thereby forming a stack of substrates that includes the first substrate and the second substrate; and g) control the second robotic actuator to move the frame to the assembly station with the frame oriented such that the frame is placed over the stack of substrates residing at the assembly station at the predetermined position and the stack of substrates is disposed within the frame rabbet. The plurality of fasteners installed within the frame secures the stack of substrates within the frame rabbet to form the framed display item.

In any of the aspects or embodiments described above and herein, the stored instructions when executed may cause the system controller to control the second actuator to pick the framed display item from the assembly station and move the framed display item to an exit station.

In any of the aspects or embodiments described above and herein, the system may include a plurality of interchangeable assembly stations, including a first assembly station configured to be used to assemble a first type of framed display item and a second assembly station configured to be used to assemble a second type of framed display item. The first type of framed display item is configured differently from the second type of framed display item.

In any of the aspects or embodiments described above and herein, the first type of framed display item may include a first frame having a first geometric configuration, and the second type of framed display item may include a second frame having a second geometric configuration. The first geometric configuration is different from the second geometric configuration.

The foregoing has outlined several aspects of the present invention in order that the detailed description of the invention that follows may be better understood. Additional features and advantages of the invention will be described hereinafter which form the subject of the claims of the invention.

### BRIEF DESCRIPTION OF THE DRAWING

FIG. 1 is a diagrammatic view of a present disclosure system embodiment.

FIG. 2A is a diagrammatic example of a framed display item having a single substrate.

FIG. 2B is a diagrammatic example of a framed display item having two substrates.

FIG. 2C is a diagrammatic example of a framed display item having three substrates.

FIG. 2D is a diagrammatic example of a framed display item having four substrates.

FIG. 3 is a diagrammatic view of a present disclosure system embodiment.

### DETAILED DESCRIPTION

Aspects of the present disclosure include a method and system for automated assembly of framed display item. Non-limiting examples of framed display item include artwork, posters, photographs, mirrors, signage, and the like mounted within a frame. Some framed display items may be configured for mounting on a vertical surface such as a wall or a door and therefore may be described as being “wall decor”. Some framed display items may be configured for mounting on a pedestal or similar support systems and therefore not mounted on a vertical surface. The present disclosure relates to automated assembly of framed display items and therefore is not limited how the framed display item is used or mounted thereafter.

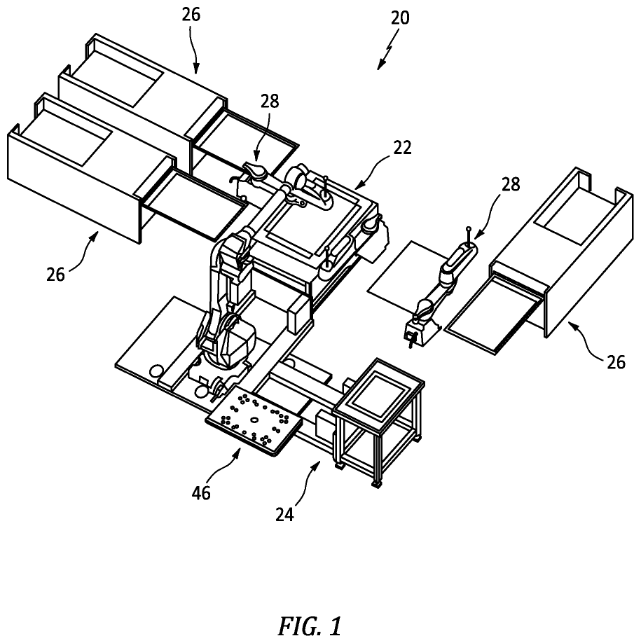

Embodiments of the present disclosure method and system are configurable to produce a variety of different framed display items. FIG. 1 illustrates an example of a present disclosure system 20 that includes an assembly station 22, a frame supply station 24, at least one substrate feeder 26, and a plurality of robotic actuators 28 each configured to move and position one or more substrate materials or frame of the framed display item as will be described below.

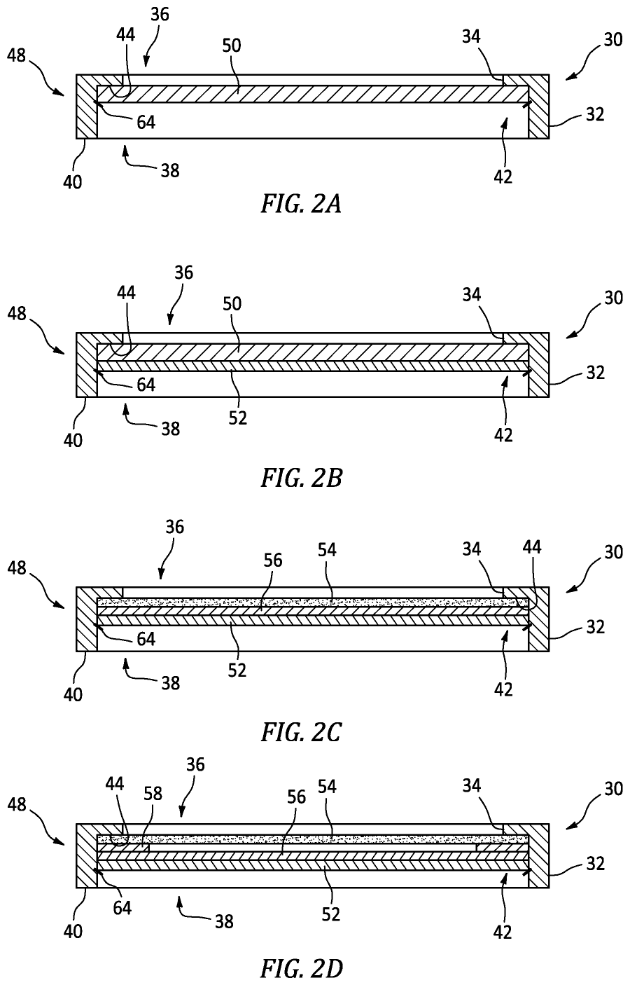

The term “frame” as used herein refers to a structure that is configured to mount and support display materials. A frame 30 (See FIGS. 2A-2D) may comprise a variety of different materials (e.g., wood, plastic, metal, etc.) and the present disclosure not limited to using frames 30 of any particular material. The present disclosure can be used with a variety of different geometric configuration frames 30 (e.g., square, rectangular, oval, elliptical, round, etc.) and is not limited to any particular frame 30 geometric configuration. A frame 30 typically includes at least one frame member that defines an exterior perimeter 32 and an interior perimeter 34. The interior perimeter 34 defines the opening of the frame 30 through which the display material may be viewed. In some embodiments, the frame 30 may be a unitary structure; i.e., a single frame member that defines the exterior perimeter 32 and the interior perimeter 34. A one-piece molded plastic frame 30 is an example of a unitary structure. In some embodiments, the frame 30 may be an assembled structure; i.e., a plurality of frame members attached to one another to define the exterior and interior perimeters 32, 34. A wooden frame 30 formed from a pair of side frame members and a pair of end frame members attached to one another is a non-limiting example of an assembled frame 30. The present disclosure is not limited to any particular frame 30 construction. Each frame 30 has a front side 36 and a rear side 38. The front side 36 is the side through which the display material is visible, and the rear side 38 is the opposite side. In many instances the rear side 38 of the frame 30 has a rear side surface 40 and a rabbet 42 formed in the frame 30 extending around and contiguous with the interior perimeter 34. The rabbet 42 may be described as forming a shelf 44 in which the display materials are disposed as will be described herein.

As will be described herein, embodiments of the present disclosure may access frames 30 disposed at a frame supply station 24. The frames 30 disposed in the frame supply station 24 may be provided from a source independent of the present disclosure system 20 (e.g., assembled elsewhere and sourced to the present system 20) or the present disclosure system 20 may be configured to receive frames 30 from one or more automated frame assembly devices; e.g., the automated frame assembly device may be a part of the system 20. An example of an automated frame assembly device is the Alfamacchine AF-500 Frame Robot System offered by the Fletcher Business Group. This robotic device is operable to join pre-cut frame members together to form frames 30 in a high-speed precision manner. The present disclosure is not limited to any particular source of frames 30 or any particular automated frame assembly device. A variety of different frame supply station 24 configurations may be used with the present disclosure. For example, in some embodiments the frame supply station 24 may be configured to horizontally feed frames 30 from a “buffer reserve” to a position where the frame 30 can be picked by a robotic actuator 28. A specific non-limiting example of how this may be accomplished involves tooling (pneumatically or otherwise actuated) that loads frames 30 onto a feed conveyor. Additional tooling may separate a “lead frame” (i.e., the next frame 30 up) from the other frames 30 on the conveyor, and the lead frame 30 can then be further conveyed on the conveyor until it reaches a reference surface. Once at the reference surface, the system 20 may use additional tooling to locate and grip the frame 30, and in some embodiments may also inspect the frame 30 to verify the frame 30 dimensions are within acceptable parameter ranges. The tooling used to locate and inspect may include mechanical probes (e.g., pneumatic actuators) or electronic sensors (e.g., a linear variable differential transformer or “LVDT” type sensor), or any combination thereof. If the frame 30 is found to be acceptable, the frame may then be moved (e.g., by robotic actuator 28) from the conveyor to a pick-off station which may be referred to as a “dead nest station 46”. If the frame 30 is found to be unacceptable, the frame 30 may then be moved (e.g., by robotic actuator 28) to a rejection area for removal from the system 20. The tooling used to grip the frame 30 may depend on the type of frame 30 being used. The present disclosure is not limited to any particular type of tooling to grip the frame 30; e.g., the tooling may use mechanical features to grip the frame 30 or may use suction cups to grip the frame 30, or the like. In many instances, the use of suction cups to grip the frame 30 is advantageous to avoid marking the frame 30.

The present disclosure system 20 may be configured to produce a variety of different types of framed display items 48, including framed display items 48 that have one or more than one constituent substrates. An example of a framed display item 48 that includes a single substrate is a mirror 50 that may be mounted in a frame 30 without additional substrates (e.g., see FIG. 2A). An example of a framed display item 48 that includes more than one substrate is a mirror 50 that may be mounted with a backing substrate 52 (e.g., See FIG. 2B). Another example of a framed display item 48 that includes more than one substrate is one that includes a protective substrate 54, the display material 56 (i.e., the poster, photograph, print, or artwork), and a backing substrate 52 (e.g., See FIG. 2C). Another example of a framed display item that includes more than one substrate is one that includes a protective substrate 54, a mat 58 (e.g., that provides a border around the display material 56), a display material 56 (i.e., poster, photograph, print, or artwork), and a backing substrate 52 (e.g., See FIG. 2D). These are non-limiting examples of framed display item 48 that can be produced using the present disclosure system 20.

Each substrate material that is to be included in the framed display item 48 may be fed into production from a substrate feeder 26 that stores a number of the substrates to be used in the automated process. The substrate feeder 26 may be configured and controlled to dispense one substrate at a time to a tray or the like for each framed display item 48 production cycle. In some embodiments, the substrate feeder 26 may be configured to dispense and locate the dispensed substrate to a known location to facilitate removal of the substrate from the substrate feeder 26. A non-limiting example of a substrate feeder 26 is a HSF28 Friction Feeder manufactured by Pineberry Manufacturing Inc. of Oakville, Ontario, Canada. Each substrate feeder 26 is typically configured to store and feed a particular substrate; e.g., configured to handle that substrate according to the physical attributes of that particular substrate.

Some of the robotic actuators 28 may be configured to pick up a substrate of the framed display item 48 from the substrate feeder 26 dispensing that substrate material and move that substrate material to another station. The manner in which the robotic actuator 28 picks up and moves the substrate material to the assembly station 22 may depend on the particular substrate material being picked and moved. For example, the robotic actuator 28 may be configured to pick-up a substrate material using suction or vacuum. A non-limiting example of a robotic actuator 28 that may be used with the present disclosure is a SCARA (Selective Compliance Assembly Robot Arm) robot equipped with an EOAT (End of Arm Tooling) that is configured to be able to pick up and move a particular substrate material. A non-limiting specific example of a SCARA robot that may be used with the present system 20 is a SR-12iA SCARA six axis robot manufactured by FANUC America of Rochester Hills, Mich. The robotic actuator 28 and its EOAT are typically configured to pick up and move a particular substrate material based on the physical attributes (e.g., size, weight, material, etc.) of that particular substrate. In some embodiments, a robotic actuator 28 may be dedicated to pick up a substrate material from a particular substrate feeder 26 and move that substrate material from that substrate feeder 26 to the assembly station 22. In other embodiments, a robotic actuator 28 may be dedicated to pick up and move a plurality of different substrate materials during the assembly process; e.g., pick up a first substrate material from a first substrate feeder 26 and move that substrate material from the first substrate feeder 26 to the assembly station 22, and also pick up a second substrate material from a second substrate feeder 26 and move that substrate material from the second substrate feeder 26 to the assembly station 22, etc. Some robotic actuators 28 may be configured to pick up a substrate of the framed display item 48 from the substrate feeder 26 dispensing that substrate material and move that substrate material to an intermediate station (e.g., an adhesive station, or a protective film removal station, etc.) as will be described herein. Some robotic actuators 28 may be configured to pick up a substrate material from an intermediate station and move it to another intermediate station, or from an intermediate station and move it to the assembly station 22 as will be described herein. One of the robotic actuators 28 is configured to pick up a frame 30 from the dead nest station 46 and move it to the assembly station 22. That same robotic actuator 28 may also be used to move a rejected frame 30 to a rejection area for removal from the system 20.

It may be desirable when assembling some framed display items 48 to apply an adhesive to some or all of a surface of a substrate material. In those applications, the present disclosure system 20 may include an adhesive station 60 configured to apply a desired amount of adhesive to some or all of a surface of a substrate material. The adhesive station 60 may be placed as an intermediate station between a substrate feeder 26 (i.e., the substrate feeder 26 for the substrate to which the adhesive is applied) and the assembly station 22 or placed as an intermediate station between another intermediate station and the assembly station 22. To illustrate, a specific non-limiting example of an adhesive station 60 is described hereinafter that includes an adhesive supply unit that is configured and controlled to apply a bead of hot glue to a surface of a protective substrate (e.g., a transparent polymeric substrate such as an acrylic panel) adjacent each side edge of the substrate surface. The adhesive supply unit may utilize a plurality of applicators to apply the aforesaid beads of adhesive to the substrate surface. A servo controlled ball screw may be used to horizontally actuate each applicator relative to the substrate. An ITW Dynamelt™ SR adhesive supply unit (produced by ITW Dynatec Americas of Henderson, Tenn. USA) is a non-limiting example of an adhesive supply unit that may be used. A robotic actuator 28 may be used to pick the substrate from the adhesive station 60 and move it to the assembly station 22.

In some applications, a substrate to be included within the framed display item 48 may have a protective film applied to a surface of that substrate to protect the substrate during handling. In these embodiments, the present disclosure may include a film removal station 62 configured and controlled to remove the protective film from the substrate surface. The film removal station 62 may include a means for securing the substrate to the station 62 (e.g., a vacuum surface that holds the substrate to a surface using vacuum) and one or more air knives configured and controlled to produce a body of air at one or more edges of the substrate bearing the protective film. The body of air is configured to separate the protective film from the substrate surface. The air knives may traverse horizontally (e.g., parallel with the substrate) until the protective layer is completely separated from the substrate. A hood may be mounted above the film removal station 62 configured to draw air up and away from the substrate; e.g., an updraft. The airflow drawn into the hood is sufficient to draw the protective film away from the substrate and convey it to a scrap hopper or otherwise handle the no longer needed protective film. A robotic actuator 28 may be used to pick the substrate (now with the protective film removed) from the film removal station 62 and move it to an intermediate station (e.g., the adhesive station 60) or the assembly station 22.

The assembly station 22 is configured to receive the one or more substrates that will be included within the framed display item 48. The assembly station 22 may include tooling (e.g., actuators, sensors, etc.) configured to locate the substrates as they are moved to the assembly station 22 from the respective satellite stations. In some embodiments, the assembly station 22 may include one or more devices for installing fasteners 64 into a frame 30 to hold the respective substrates within the framing display item 48 being assembled. The type of device for installing fasteners 64 into a frame 30 may vary depending on the type of frame 30. For example, in those types of frames 30 comprising a material (e.g., wood, etc.) that can receive a fastener 64 driven into the frame material, one or more pneumatic nail guns may be configured and controlled to drive fasteners 64 into the frame material. Non-limiting examples of fastener types include points or tabs conventionally used in picture framing; e.g., FlexiPoints or Framer's points offered by the Fletcher Business Group. For those types of frames 30 that comprise a material that is not amenable to receive a driven fastener 64 (e.g., a metal frame), the devices for installing fasteners 64 into the frame 30 may be configured to install a different type of fastener (e.g., a metal screw). The number of devices for installing fasteners 64 into a frame 30 may vary depending on the framed display item 48 being assembled. For example, a total of fourteen (14) nail guns may be used within an assembly station 22 configured to assemble 16 inch×20 inch and 18 inch×24 inch rectangular shaped framed display items 48 having a wooden frame 30, while an assembly station 22 configured to assemble 24 inch×36 inch rectangular shaped framed display items 48 having a wooden frame 30 may include a total of eighteen (18) nail guns.

In some system 20 embodiments, a present disclosure system 20 may include a plurality of different interchangeable assembly station embodiments that can be utilized within the system 20. Each different assembly station 22 embodiment may be configured to assemble one or more different types of framed display items 48. In these embodiments, each of the interchangeable assembly table embodiments may be mounted on rollers and may be configured for docking within the system 20 to facilitate removal from and insertion into the system 20. These interchangeable assembly stations 22 may be configured for ready connection to a pneumatic source and/or electrical power and control systems via plugs or other connectors.

In some embodiments, the present disclosure system 20 may be configured to produce an assembled framed display item 48 that includes one or more hanger devices for hanging the assembled framed display item on a vertical surface. Some system 20 embodiments may include a hanger station 66 configured to attach one or more hanger devices onto a substrate (e.g., a backing substrate). In these embodiments, tooling (e.g., actuators and sensors) included in the hanger station 66 (or a robotic actuator 28 in communication with the hanger station 66) may be configured to position and attach the one or more hangers at a predetermined position(s) on the substrate. In other embodiments, the hanger station 66 may be configured to receive an assembled framed display item 48 and install the hangers on the received assembled framed display item 48. In these embodiments, the hanger station 66 may be configured to attach the one or more hanger devices onto a back surface of an assembled framed display item 48; e.g., onto a rear surface of a frame 30 or onto a rear surface of the rearmost substrate of the assembled framed display item. In still other embodiments, the assembly station 22 may be configured (e.g., tooling or in communication with a robotic actuator 28) to attach hanger brackets onto a back surface of an assembled framed display item 48.

The present disclosure system 20 includes a system controller 68 in communication with the components (e.g., assembly station 22, frame supply station 24, substrate feeder(s) 26, robotic actuators 28, film removal station 62, adhesive station 60, etc.) that may be present in the various embodiments of the present disclosure system 20. The system controller 68 may be configured to execute stored instructions (e.g., algorithmic instructions) that cause the present disclosure system 20 to perform steps or functions described herein. The system controller 68 may include any type of computing device, computational circuit, or any type of process or processing circuit capable of executing a series of instructions that are stored in memory. The system controller 68 may include multiple processors and/or multicore CPUs and may include any type of processor, such as a microprocessor, digital signal processor, co-processors, a micro-controller, a microcomputer, a central processing unit, a field programmable gate array, a programmable logic device, a state machine, logic circuitry, analog circuitry, digital circuitry, etc., and any combination thereof. Some of the system 20 stations described herein may themselves have a processor; e.g., an independent processor dedicated to that respective station, any and all of which processors may be in communication with the system controller 68. The instructions stored in memory may represent one or more algorithms for controlling the system 20 as described herein, and the stored instructions are not limited to any particular form (e.g., program files, system data, buffers, drivers, utilities, system programs, etc.) provided they can be executed by the system controller 68. The system controller 68 memory may be a non-transitory machine readable storage medium configured to store instructions that when executed by one or more processors, cause the one or more processors to perform or cause the performance of certain functions. The memory may be a single memory device or a plurality of memory devices. The present disclosure system controller is not limited to any particular type of memory device. One skilled in the art will appreciate, based on a review of this disclosure, that the implementation of the system controller 68 may be achieved via the use of hardware, software, firmware, or any combination thereof. Communications between system stations or components may be by wired connection or may be by wireless communication, or any combination thereof.

Some embodiments of the present disclosure system 20 may include an operator station 70 located at or remote from the assembly system 20. The operator station 70 may include one or more input devices (e.g., a keyboard, a touch screen, communication input ports, terminals, wireless communication devices, etc.) and/or one or more output devices (a monitor, data readouts, communication output ports, terminals, wireless communication devices, etc.) that enable signals and/or communications to be sent to and/or received by the system controller 68.

Some embodiments of the present disclosure may include an exit station 72 configured to move an assembled framed display item 48 from the system 20 to a collection area, or to a station for packaging the assembled framed display item 48. The exit station 72 may include a horizontal transport means such as a conveyor belt. A robotic actuator 28 may be used to pick the assembled framed display item 48 from the assembly station 22 and move it to the exit station 72.

All of the various stations within the present disclosure system 20 are either located at known spatial locations, or may be spatially located, so that the robotic actuators 28 may repeatably move substrates and frames 30 relative to one another as described herein. In some embodiments, some or all of the stations may be attached to one another to accomplish the known spatial locations. In some embodiments, once the system stations are installed the system 20 may be configured to execute a set-up procedure to determine the station locations and may include calibration instructions to calibrate relative component positions, as necessary.

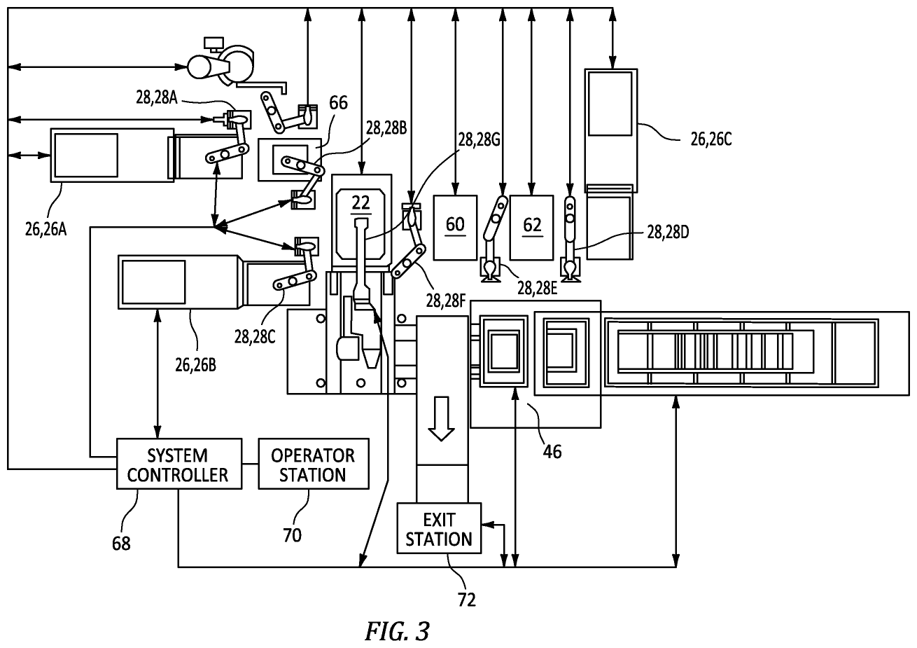

To illustrate the utility of the present disclosure, a specific non-limiting example of the operation of the assembly system 20 is hereinafter provided. The following operational example describes how a framed display item having a frame 30, a protective substrate 54, a display material 56 (e.g., a piece of artwork, a photograph, a poster, or the like), and a backing substrate 52. In this example as shown in FIG. 3, the system 20 includes an operator station 70, a frame supply station 24, a backing substrate feeder (“BS feeder 26A”), a backing substrate robotic actuator (“BS robotic actuator 28A”), a hanger station 66, a hanger station robotic actuator (“HS robotic actuator 28B”), a display material feeder (“DM feeder 26B”), a display material robotic actuator (“DM robotic actuator 28C”), a protective substrate feeder (“PS feeder 26C”), a protective substrate robotic actuator (“PS robotic actuator 28D”), a film removal station 62, a film removal station robotic actuator (“FRS robotic actuator 28E”), an adhesive station 60, an adhesive station robotic actuator (“ADS robotic actuator 28F”), an assembly station 22, an assembly station robotic actuator (“AS robotic actuator 28G”), and an exit station 72. The operator station 70 is in communication with the system controller 68 and with some or all the various stations and robotic actuators within the system 20. In the description below, the various components within the system 20 may be described as being “controlled” to perform a given task. Instructions stored within the system controller 68 (or a local processor) may be used to accomplish the control of the respective component.

In operation of the system 20, the BS feeder 26A is controlled to dispense a backing substrate 52 to a tray. The BS robotic actuator 28A is controlled to pick the dispensed backing substrate 52 from the BS feeder 26A tray and move it to the hanger station 66. The hanger station 66 is controlled to attach one or more hanger devices to the backing substrate 52. The HS robotic actuator 28B is controlled to move the backing substrate 52 (now with one or more hanger devices) to the assembly station 22. During the movement of the backing substrate 52 to the assembly station 22, the HS robotic actuator 28B may be controlled to flip the backing substrate 52 so the surface of the backing substrate 52 bearing the hanger devices is placed down on the assembly station 22. The assembly station 22 is controlled to locate and position the backing substrate 52 in a predetermined location. The backing substrate 52 begins the “stack” of substrates that will form the assembled framed display item 48. Next (or concurrently with), the DM feeder 26B is controlled to dispense a display material substrate 56 to a tray. The DM robotic actuator 28C is controlled to pick the dispensed display material substrate 56 from the DM feeder 26B tray and move it to the assembly station 22. Here again, the assembly station 22 may be controlled to locate and position the display material substrate 56 in the predetermined location (i.e., aligned with the backing substrate 52), thereby forming the second layer of the substrate stack. Next (or concurrently with), the PS feeder 26C is controlled to dispense a protective substrate 54 to a tray. The PS robotic actuator 28D is controlled to pick the dispensed protective substrate 54 from the PS feeder 26C tray and move it to the film removal station 62. The film removal station 62 is controlled to remove the protective film from the protective substrate 54. The FRS robotic actuator 28E is controlled to pick the protective substrate 54 (now without the protective film) and move it to the adhesive station 60. The adhesive station 60 is controlled to apply one or more beads of hot glue to the exposed surface of the protective substrate 54 adjacent each side edge of the substrate surface. The ADS robotic actuator 28F is controlled to pick the protective substrate 54 (now with dispensed glue) from the adhesive station 60 and move it to the assembly station 22. Once again, the assembly station 22 may be controlled to locate and position the protective substrate 54 in the predetermined location (i.e., aligned with the substrate stack), thereby forming the third layer of the substrate stack. Next the AS robotic actuator 28G is controlled to pick the frame 30 and move it to the assembly station 22. When the frame 30 is delivered to the assembly station 22, the frame 30 is oriented such that the rear surface 40 of the frame 30 (i.e., the side with the rabbets 42) is downwardly positioned to receive the substrate stack. In other words, the AS robotic actuator 28G places the frame 30 over the substrate stack so that the stack may be received within the frame rear surface rabbet 42. In some embodiments, the AS robotic actuator 28G may be controlled to apply pressure to the frame 30 to compress the substrate stack, including the glue now disposed between the frame shelf 44 and the protective substrate 54. Once the substrate stack has been received and is disposed (e.g., compressed) to the proper position within the frame rabbet 42, the nail guns within the assembly station 22 may be actuated to install fasteners into the frame 30 at predetermined positions to secure the substrate stack within the frame 30. Subsequently, the now finished framed display item 48 may be picked from the assembly station 22 by the AS robotic actuator 28G and moved to the exit station 72. Subsequently, the assembly process described above may be repeated to produce another framed display item.

The present system 20 and method provide numerous advantages over existing framing systems and methods. For example, the production of a substrate stack and the application of the frame 30 to the substrate stack as described above may be described as the “reverse” of known assembly processes. This “reverse” assembly enables a faster production process with a decreased probability of process failure. As one skilled in the art will recognize, there is great value in having an automated assembly process that is less prone to failures within the process. A failure in the process equates to assembly stoppage and manual and therefore expensive human intervention. Another significant advantage of the present disclosure is its ability to handle a variety of different framed display items. Additional or fewer substrate feeders 26 and robotic actuators 28 may be used depending on the particular framed display item 48 being produced. Instructions for a variety of different framed display items 48 can be stored within and implemented by the system controller 68. System 20 components can be swapped out (e.g., different assembly stations 22, substrate feeders 26, adhesive stations 60, film removal stations 62, etc.) to accommodate the various different framed display items 48 as required. Hence, a single system may be used to produce a variety of different existing framed display items 48 and can accommodate new framed display items in the future with minimal system modification.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

1. A method for assembling framed display items, comprising:
providing at least one substrate feeder, and controlling the at least one substrate feeder to dispense a first substrate;
using a first robotic actuator to pick the dispensed first substrate and move the first substrate from the substrate feeder to an assembly station;
locating the first substrate to a predetermined position on the assembly station;
using a second robotic actuator to pick a frame from a frame station and moving the frame to the assembly station, the frame having a front side, a rear side, an outer perimeter, and an inner perimeter, the inner perimeter defining an opening, the rear side having a rear side surface that includes a rabbet extending around and contiguous with the inner perimeter, the rabbet forming a shelf surface;
wherein the second robotic actuator is configured to move the frame from a frame station to the assembly station with the frame oriented such that the frame is placed over the first substrate residing at the assembly station and the first substrate is disposed within the frame rabbet; and
installing a plurality of fasteners within the frame to secure the first substrate within the frame rabbet.

2. The method of claim 1, further comprising controlling the assembly station to position the first substrate to the predetermined position of the assembly station.

3. The method of claim 2, wherein the at least one substrate feeder includes a first substrate feeder that dispenses the first substrate and a second substrate feeder that dispenses a second substrate, and further comprising:
using the first robotic actuator to pick the second substrate from the second substrate feeder and move the second substrate to the assembly station;
controlling the assembly station to position the second substrate to the predetermined position of the assembly station on top of the first substrate, thereby forming a stack of substrates that includes the first substrate and the second substrate; and
wherein the second robotic actuator is configured to move the frame to the assembly station with the frame oriented such that the frame is placed over the stack of substrates residing at the assembly station at the predetermined position and the stack of substrates is disposed within the frame rabbet; and
wherein the step of installing the plurality of fasteners within the frame secures the stack of substrates within the frame rabbet.

4. The method of claim 2, wherein the at least one substrate feeder includes a first substrate feeder that dispenses the first substrate and a second substrate feeder that dispenses a second substrate, and further comprising:
using a third robotic actuator to pick the second substrate from the second substrate feeder and move the second substrate to the assembly station; and
controlling the assembly station to position the second substrate to the predetermined position of the assembly station on top of the first substrate, thereby forming a stack of substrates that includes the first substrate and the second substrate; and
wherein the second robotic actuator is configured to move the frame to the assembly station with the frame oriented such that the frame is placed over the stack of substrates residing at the assembly station at the predetermined position and the stack of substrates is disposed within the frame rabbet; and
wherein the step of installing the plurality of fasteners within the frame secures the stack of substrates within the frame rabbet.

5. The method of claim 4, wherein the at least one substrate feeder further includes a third substrate feeder that dispenses a third substrate, and further comprising:
using a fourth robotic actuator to pick the third substrate from the third substrate feeder and move the third substrate to the assembly station; and
controlling the assembly station to position the third substrate to the predetermined position of the assembly station on top of the second substrate, thereby adding the third substrate to the stack of substrates.

6. The method of claim 2, wherein the at least one substrate feeder includes a first substrate feeder that dispenses the first substrate and a second substrate feeder that dispenses a second substrate, and further comprising:
using a third robotic actuator to pick the second substrate from the second substrate feeder and move the second substrate to an adhesive station;
controlling the adhesive station to apply an amount of adhesive to a surface of the second substrate;
using a fourth robotic actuator to pick the second substrate from the adhesive station and move the second substrate to the assembly station;
controlling the assembly station to position the second substrate to the predetermined position of the assembly station on top of the first substrate, thereby forming a stack of substrates that includes the first substrate and the second substrate; and
wherein the second robotic actuator is configured to move the frame to the assembly station with the frame oriented such that the frame is placed over the stack of substrates residing at the assembly station at the predetermined position and the stack of substrates is disposed within the frame rabbet and the amount of adhesive applied to the surface of the second substrate is disposed between and in contact with the shelf surface of the frame and the second substrate surface; and
wherein the step of installing the plurality of fasteners within the frame secures the stack of substrates within the frame rabbet.

7. The method of claim 2, wherein the at least one substrate feeder includes a first substrate feeder that dispenses the first substrate and a second substrate feeder that dispenses a second substrate, and further comprising:
using a third robotic actuator to pick the second substrate from the second substrate feeder and move the second substrate to a film removing station;
controlling the film removing station to remove a protective film attached to a surface of the second substrate;
using a fourth robotic actuator to pick the second substrate from the film removing station and move the second substrate to the assembly station;
controlling the assembly station to position the second substrate to the predetermined position of the assembly station on top of the first substrate, thereby forming a stack of substrates that includes the first substrate and the second substrate; and
wherein the second robotic actuator is configured to move the frame to the assembly station with the frame oriented such that the frame is placed over the stack of substrates residing at the assembly station at the predetermined position and the stack of substrates is disposed within the frame rabbet; and
wherein the step of installing the plurality of fasteners within the frame secures the stack of substrates within the frame rabbet.

8. The method of claim 2, wherein the at least one substrate feeder includes a first substrate feeder that dispenses the first substrate and a second substrate feeder that dispenses a second substrate, and further comprising:
using a third robotic actuator to pick the second substrate from the second substrate feeder and move the second substrate to a film removing station;
controlling the film removing station to remove a protective film attached to a surface of the second substrate;
using a fourth robotic actuator to pick the second substrate from the film removing station and move the second substrate to an adhesive station;
controlling the adhesive station to apply an amount of adhesive to a surface of the second substrate;
using a fifth robotic actuator to pick the second substrate from the adhesive station and move the second substrate to the assembly station;
controlling the assembly station to position the second substrate to the predetermined position of the assembly station on top of the first substrate, thereby forming a stack of substrates that includes the first substrate and the second substrate; and
wherein the second robotic actuator is configured to move the frame to the assembly station with the frame oriented such that the frame is placed over the stack of substrates residing at the assembly station at the predetermined position and the stack of substrates is disposed within the frame rabbet; and
wherein the step of installing the plurality of fasteners within the frame secures the stack of substrates within the frame rabbet to form the framed display item.

9. The method of claim 8, further comprising using the second actuator to pick the framed display item from the assembly station and move the framed display item to an exit station.

10. A system for assembling framed display items, comprising:
at least one substrate feeder;
a first robotic actuator;
a second robotic actuator;
an assembly station;
a frame station; and
a system controller in communication with the at least one substrate feeder, the first robotic actuator, the second robotic actuator, and the assembly station, the controller including at least one processor and a memory device configured to store instructions, the stored instructions when executed cause the controller to:
control the at least one substrate feeder to dispense a first substrate;
control the first robotic actuator to pick the dispensed first substrate and move the first substrate from the substrate feeder to an assembly station;
control the assembly station to locate the first substrate to a predetermined position on the assembly station;
control the second robotic actuator to pick a frame from the frame station and move the frame to the assembly station, the frame having a front side, a rear side, an outer perimeter, and an inner perimeter, the inner perimeter defining an opening, the rear side having a rear side surface that includes a rabbet extending around and contiguous with the inner perimeter, the rabbet forming a shelf surface;
control the second robotic actuator to move the frame from the frame station to the assembly station with the frame oriented such that the frame is placed over the first substrate residing at the assembly station and the first substrate is disposed within the frame rabbet; and
control the assembly station to install a plurality of fasteners within the frame to secure the first substrate within the frame rabbet.

11. The system of claim 10, wherein the stored instructions when executed cause the system controller to control the assembly station to position the first substrate to the predetermined position of the assembly station.

12. The system of claim 11, wherein the at least one substrate feeder includes a first substrate feeder configured to dispense the first substrate and a second substrate feeder configured to dispense a second substrate;
wherein the stored instructions when executed cause the system controller to:
control the first robotic actuator to pick the second substrate from the second substrate feeder and move the second substrate to the assembly station; and
control the assembly station to position the second substrate to the predetermined position of the assembly station on top of the first substrate, thereby forming a stack of substrates that includes the first substrate and the second substrate; and
control the second robotic actuator to move the frame to the assembly station with the frame oriented such that the frame is placed over the stack of substrates residing at the assembly station at the predetermined position and the stack of substrates is disposed within the frame rabbet; and
wherein the plurality of fasteners installed within the frame secures the stack of substrates within the frame rabbet.

13. The system of claim 11, wherein the at least one substrate feeder includes a first substrate feeder configured to dispense the first substrate and a second substrate feeder configured to dispense a second substrate;
wherein the system further comprises a third robotic actuator; and
wherein the stored instructions when executed cause the system controller to:
control the third robotic actuator to pick the second substrate from the second substrate feeder and move the second substrate to the assembly station; and
control the assembly station to position the second substrate to the predetermined position of the assembly station on top of the first substrate, thereby forming a stack of substrates that includes the first substrate and the second substrate; and
control the second robotic actuator to move the frame to the assembly station with the frame oriented such that the frame is placed over the stack of substrates residing at the assembly station at the predetermined position and the stack of substrates is disposed within the frame rabbet; and
wherein the plurality of fasteners installed within the frame secures the stack of substrates within the frame rabbet.

14. The system of claim 13, wherein the at least one substrate feeder further includes a third substrate feeder configured to dispense a third substrate; and
wherein the system further comprises a fourth robotic actuator; and
wherein the stored instructions when executed cause the system controller to:
control the fourth robotic actuator to pick the third substrate from the third substrate feeder and move the third substrate to the assembly station; and
control the assembly station to position the third substrate to the predetermined position of the assembly station on top of the second substrate, thereby adding the third substrate to the stack of substrates.

15. The system of claim 11, wherein the at least one substrate feeder includes a first substrate feeder that dispenses the first substrate and a second substrate feeder that dispenses a second substrate; and
wherein the system further comprises a third robotic actuator, a fourth robotic actuator, and an adhesive station; and
wherein the stored instructions when executed cause the system controller to:
control the third robotic actuator to pick the second substrate from the second substrate feeder and move the second substrate to the adhesive station;
control the adhesive station to apply an amount of adhesive to a surface of the second substrate;
control the fourth robotic actuator to pick the second substrate from the adhesive station and move the second substrate to the assembly station;
control the assembly station to position the second substrate to the predetermined position of the assembly station on top of the first substrate, thereby forming a stack of substrates that includes the first substrate and the second substrate; and
control the second robotic actuator to move the frame to the assembly station with the frame oriented such that the frame is placed over the stack of substrates residing at the assembly station at the predetermined position and the stack of substrates is disposed within the frame rabbet; and
wherein the plurality of fasteners installed within the frame secures the stack of substrates within the frame rabbet.

16. The system of claim 11, wherein the at least one substrate feeder includes a first substrate feeder that dispenses the first substrate and a second substrate feeder that dispenses a second substrate;
wherein the system further comprises a third robotic actuator, a fourth robotic actuator, and a film removing station; and
wherein the stored instructions when executed cause the system controller to:
control the third robotic actuator to pick the second substrate from the second substrate feeder and move the second substrate to the film removing station; and
control the film removing station to remove a protective film attached to a surface of the second substrate;
control the fourth robotic actuator to pick the second substrate from the film removing station and move the second substrate to the assembly station;
control the assembly station to position the second substrate to the predetermined position of the assembly station on top of the first substrate, thereby forming a stack of substrates that includes the first substrate and the second substrate; and
control the second robotic actuator to move the frame to the assembly station with the frame oriented such that the frame is placed over the stack of substrates residing at the assembly station at the predetermined position and the stack of substrates is disposed within the frame rabbet; and
wherein the plurality of fasteners installed within the frame secures the stack of substrates within the frame rabbet.

17. The system of claim 11, wherein the at least one substrate feeder includes a first substrate feeder that dispenses the first substrate and a second substrate feeder that dispenses a second substrate;
wherein the system further comprises a third robotic actuator, a fourth robotic actuator, a fifth robotic actuator, a film removing station, and an adhesive station;
wherein the stored instructions when executed cause the system controller to:
control the third robotic actuator to pick the second substrate from the second substrate feeder and move the second substrate to the film removing station;
control the film removing station to remove a protective film attached to a surface of the second substrate;
control the fourth robotic actuator to pick the second substrate from the film removing station and move the second substrate to the adhesive station;
control the adhesive station to apply an amount of adhesive to a surface of the second substrate;
control the fifth robotic actuator to pick the second substrate from the adhesive station and move the second substrate to the assembly station;
control the assembly station to position the second substrate to the predetermined position of the assembly station on top of the first substrate, thereby forming a stack of substrates that includes the first substrate and the second substrate; and
control the second robotic actuator to move the frame to the assembly station with the frame oriented such that the frame is placed over the stack of substrates residing at the assembly station at the predetermined position and the stack of substrates is disposed within the frame rabbet; and
wherein the plurality of fasteners installed within the frame secures the stack of substrates within the frame rabbet to form the framed display item.

18. The system of claim 17, wherein the stored instructions when executed cause the system controller to control the second actuator to pick the framed display item from the assembly station and move the framed display item to an exit station.

19. The system of claim 11, wherein the system includes a plurality of interchangeable assembly stations, including a first assembly station configured to be used to assemble a first type of framed display item and a second assembly station configured to be used to assemble a second type of framed display item, wherein the first type of framed display item is configured differently from the second type of framed display item.

20. The system of claim 19, wherein the first type of framed display item includes a first frame having a first geometric configuration, and the second type of framed display item includes a second frame having a second geometric configuration, and the first geometric configuration is different from the second geometric configuration.
